(19) United States
(12) Patent Application Publication
(10) Pub. No.: US 2022/0321050 A1
(43) Pub. Date: Oct. 6, 2022

(54) DRIVE DEVICE AND DRIVE DEVICE CONTROL METHOD

(71) Applicant: NIDEC CORPORATION, Kyoto (JP)

(72) Inventor: Yusuke JONO, Kyoto (JP)

(21) Appl. No.: 17/702,790

(22) Filed: Mar. 24, 2022

(30) Foreign Application Priority Data
Mar. 30, 2021 (JP) 2021-057911

(51) Int. Cl. H02P 29/60; F16H 57/04; B60L 15/20; B60L 3/00; B60L 1/00

(52) U.S. Cl. CPC H02P 29/60; F16H 57/0436; B60L 15/20; F16H 57/0476; B60L 3/0061; B60L 1/003; B60L 2240/425

(57) ABSTRACT

A drive device including: a motor; a transmission device including a reduction gear; a housing; an electric oil pump; and a control unit including a motor control unit and an electric oil pump control unit. The electric oil pump control unit includes: control mode switching means that, in oil supply processing, switches between and executes a normal control mode in which the output of the electric oil pump is changed in a plurality of stages according to the temperature of the stator or the rotor, and a startup mode in which the electric oil pump is operated at a maximum output in the normal control mode for a predetermined time at the start of power supply; and pump driving means that operates the electric oil pump.

### CROSS-REFERENCE TO RELATED APPLICATIONS

The present invention claims priority under 35 U.S.C. § 119 to Japanese Patent Application No. 2021-057911 filed on Mar. 30, 2021, the entire content of which is incorporated herein by reference.

### FIELD OF THE INVENTION

The present invention relates to a drive device and a drive device control method.

### BACKGROUND

A drive device mounted on a vehicle and accommodating oil in a housing is known. There is a drive device including an electric oil pump. By starting the electric oil pump for a predetermined time at the start of power supply and filling an oil cooler with oil, a time loss by lubrication of the machine at the start of traveling is reduced.

On the other hand, at an extremely low temperature below the freezing point, the viscosity of automatic transmission fluid (ATF) becomes extremely high. For this reason, even if the oil cooler is filled with oil at the start of power supply, it may take time for the oil to spread over the entire drive device, leading to insufficient lubrication.

### SUMMARY

According to one aspect of the present invention, there is provided a drive device including: a motor including a rotor and a stator; a transmission device including a reduction gear connected to the motor; a housing accommodating the motor and the transmission device; an electric oil pump that conveys oil in the housing; and a control unit including a motor control unit that controls the motor and an electric oil pump control unit that controls the electric oil pump. The electric oil pump control unit includes: control mode switching means that, in oil supply processing, switches between and executes a normal control mode in which the output of the electric oil pump is changed in a plurality of stages according to the temperature of the stator or the rotor, and a startup mode in which the electric oil pump is operated at a maximum output in the normal control mode for a predetermined time at the start of power supply; and pump driving means that operates the electric oil pump.

According to another aspect of the present invention, there is provided a drive device including: a motor including a rotor and a stator; a transmission device including a reduction gear connected to the motor; a housing accommodating the motor and the transmission device; an electric oil pump that conveys oil in the housing; and a control unit including a motor control unit that controls the motor and an electric oil pump control unit that controls the electric oil pump. The electric oil pump control unit includes output setting means that sets an output of the electric oil pump in oil supply processing at the start of power supply. The output setting means sets an output of the electric oil pump within a range of an output value including a maximum output of the electric oil pump on the basis of temperature information input to the electric oil pump control unit from the motor control unit or a host device.

According to another aspect of the present invention, there is provided a method of controlling a drive device including a motor having a rotor and a stator, a transmission device including a reduction gear connected to the motor, a housing that accommodates the motor and the transmission device, and an electric oil pump that conveys oil in the housing. In oil supply processing, a normal control mode in which the output of the electric oil pump is changed in a plurality of stages according to the temperature of the stator or the rotor, and a startup mode in which the electric oil pump is operated at a maximum output in the normal control mode for a predetermined time at the start of power supply are switched and executed.

According to another aspect of the present invention, there is provided a method of controlling a drive device including a motor having a rotor and a stator, a transmission device including a reduction gear connected to the motor, a housing that accommodates the motor and the transmission device, and an electric oil pump that conveys oil in the housing. In oil supply processing at the start of power supply, the output of the electric oil pump is set within a range of an output value including a maximum output of the electric oil pump on the basis of temperature information input from a host device or the motor, and the electric oil pump is operated with the set output.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a functional block diagram of a drive device according to an embodiment;

FIG. 2 is a configuration diagram of the drive device according to the embodiment;

FIG. 3 is a flowchart illustrating a drive device control method according to the embodiment;

FIG. 4 is a graph conceptually illustrating a relationship between an elapsed time from the start of power supply and an output of an electric oil pump 96 in the embodiment;

FIG. 5 is a flowchart illustrating a drive device control method according to the embodiment; and

FIG. 6 is a flowchart illustrating a drive device control method according to the embodiment.

### DETAILED DESCRIPTION

Hereinafter, an embodiment of the invention will be described with reference to the drawings.

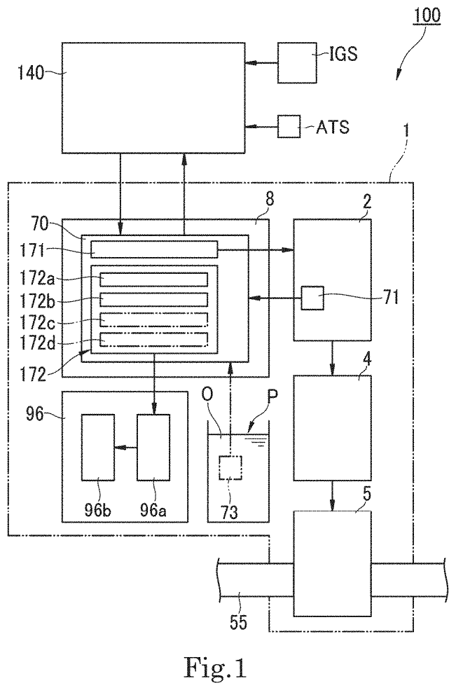

A vehicle drive system 100 illustrated in FIG. 1 is mounted on a vehicle and drives the vehicle. A vehicle equipped with the vehicle drive system 100 of the present embodiment is a motor-powered vehicle, such as a hybrid vehicle (HEV), a plug-in hybrid vehicle (PHV), and an electric vehicle (EV). The vehicle drive system 100 includes a drive device 1 and a vehicle control device 140. That is, the drive device 1 and the vehicle control device 140 are provided in the vehicle.

The vehicle control device 140 controls each device mounted on the vehicle. In the present embodiment, the vehicle control device 140 controls the drive device 1. A signal from an ignition switch IGS provided in the vehicle is input to the vehicle control device 140. The ignition switch IGS is a switch that switches driving and stopping of the drive device 1, and is directly or indirectly operated by the driver who drives the vehicle.

When the ignition switch IGS is switched from OFF to ON, the vehicle control device 140 sends a signal to the control unit 70 described later of the drive device 1 to drive the drive device 1 and bring the vehicle into a travelable state. On the other hand, when the ignition switch IGS is turned from ON to OFF, the vehicle control device 140 sends a signal to the control unit 70 to stop the drive device 1.

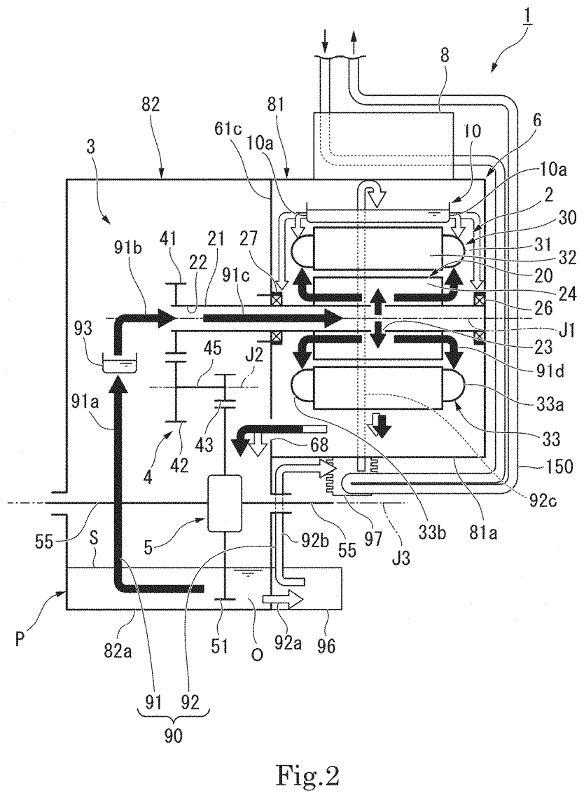

The drive device 1 is used as a power source of a motor-powered vehicle such as a hybrid vehicle (HEV), a plug-in hybrid vehicle (PHV), or an electric vehicle (EV) described above. As illustrated in FIG. 2, the drive device 1 includes a motor 2, a transmission device 3 having a reduction gear 4 and a differential gear 5, a housing 6, an inverter unit 8, an electric oil pump 96, and an oil cooler 97. The housing 6 accommodates the motor 2 and the transmission device 3. The housing 6 includes a motor accommodation part 81 accommodating the motor 2, and a gear accommodation part 82 accommodating the reduction gear 4 and the differential gear 5.

In the present embodiment, the motor 2 is an inner rotor type motor. The motor 2 includes a rotor 20, a stator 30, and bearings 26 and 27. The rotor 20 is rotatable about a motor axis J1 extending in the horizontal direction. The rotor 20 includes a shaft 21 and a rotor body 24. Although not illustrated, the rotor body 24 includes a rotor core and a rotor magnet fixed to the rotor core. The torque of the rotor 20 is transmitted to the reduction gear 4.

Note that in the following description, the horizontal direction in which the motor axis J1 extends is referred to as an “axial direction”, the radial direction centered on the motor axis J1 is simply referred to as a “radial direction”, and the circumferential direction centered on the motor axis J1, i.e., around the axis of the motor axis J1 is simply referred to as a “circumferential direction”. In the present embodiment, the axial direction is the right-left direction in FIG. 2, for example, and is the right-left direction of the vehicle, i.e., the vehicle width direction. In the following description, the right side in FIG. 2 in the axial direction is simply referred to as a “right side”, and the left side in FIG. 2 in the axial direction is simply referred to as a “left side”. The up-down direction in FIG. 2 is referred to as a vertical direction. The upper side in FIG. 2 is simply referred to as “up” as the upper side in the vertical direction, and the lower side in FIG. 2 is simply referred to as “down” as lower side in the vertical direction.

The shaft 21 is centered on the motor axis J1 and extends in the axial direction. The shaft 21 rotates about the motor axis J1. The shaft 21 is a hollow shaft with a hollow part 22 provided therein. The shaft 21 is provided with a communicating hole 23. The communicating hole 23 extends in a radial direction to join the hollow part 22 and the outside of the shaft 21.

The shaft 21 extends across the motor accommodation part 81 and the gear accommodation part 82 of the housing 6. The left end of the shaft 21 projects into the gear accommodation part 82. A first gear 41 described later of the reduction gear 4 is fixed to the left end of the shaft 21. The shaft 21 is rotatably supported by the bearings 26 and 27.

The stator 30 is arranged radially opposite to the rotor 20 with a gap therebetween. More specifically, the stator 30 is located radially outward of the rotor 20. The stator 30 includes a stator core 32 and a coil assembly 33. The stator core 32 is fixed to an inner circumferential surface of the motor accommodation part 81. Although not illustrated, the stator core 32 includes a core back in a cylindrical shape extending in the axial direction, and a plurality of teeth extending radially inward from the core back.

The coil assembly 33 includes a plurality of coils 31 attached to the stator core 32 along the circumferential direction. The plurality of coils 31 are mounted to the teeth of the stator core 32 with an insulator (not illustrated) interposed therebetween. The plurality of coils 31 are arranged along the circumferential direction. More specifically, the plurality of coils 31 are arranged at equal intervals over the entire circumference along the circumferential direction. Although not illustrated, the coil assembly 33 may include a binding member or the like that binds the coils 31 together, or may include a passage line for joining the coils 31 to one another.

The coil assembly 33 includes coil ends 33a and 33b that protrude axially from the stator core 32. The coil end 33a is a part protruding to the right side from the stator core 32. The coil end 33b is a part protruding to the left side from the stator core 32. The coil end 33a includes a part of each coil 31 included in the coil assembly 33 that protrudes to the right side of the stator core 32. The coil end 33b includes a part of each coil 31 included in the coil assembly 33 that protrudes to the left side of the stator core 32. In the present embodiment, the coil ends 33a and 33b have an annular shape centered on the motor axis J1. Although not illustrated, each of the coil ends 33a and 33b may include a binding member or the like that binds the coils 31 together, or may include a passage line for joining the coils 31 to one another.

The bearings 26 and 27 rotatably support the rotor 20. The bearings 26 and 27 are, for example, ball bearings. The bearing 26 is a bearing rotatably supporting a part of the rotor 20 located on the right side of the stator core 32. In the present embodiment, the bearing 26 supports a part of the shaft 21 located on the right side of a part to which the rotor body 24 is fixed. The bearing 26 is held by a wall part of the motor accommodation part 81 that covers the right side of the rotor 20 and the stator 30.

The bearing 27 is a bearing rotatably supporting a part of the rotor 20 located on the left side of the stator core 32. In the present embodiment, the bearing 27 supports a part of the shaft 21 located on the left side of the part to which the rotor body 24 is fixed. The bearing 27 is held by a partition wall 61c described later.

As illustrated in FIG. 1, the motor 2 includes a temperature sensor 71 that can detect the temperature of the motor 2. That is, the drive device 1 includes the temperature sensor 71. In the present embodiment, the temperature of the motor 2 is, for example, the temperature of the coil 31 of the motor 2. Although not illustrated, the temperature sensor 71 is embedded in, for example, the coil end 33a or the coil end 33b. The type of the temperature sensor 71 is not particularly limited. The detection result of the temperature sensor 71 is sent to the control unit 70 described later.

The reduction gear 4 is connected to the motor 2. More specifically, as shown in FIG. 2, the reduction gear 4 is connected to the left end of the shaft 21. The reduction gear 4 reduces the rotational speed of the motor 2 and increases the torque output from the motor 2 according to the reduction ratio. The reduction gear 4 transmits the torque output from the motor 2 to the differential gear 5. The reduction gear 4 includes the first gear 41, a second gear 42, a third gear 43, and an intermediate shaft 45.

The first gear 41 is fixed to an outer circumferential surface of the left end of the shaft 21. The first gear 41 rotates together with the shaft 21 about the motor axis J1. The intermediate shaft 45 extends along an intermediate axis J2. In the present embodiment, the intermediate axis J2 is parallel to the motor axis J1. The intermediate shaft 45 rotates about the intermediate axis J2.

Each of the second gear 42 and the third gear 43 is fixed to an outer circumferential surface of the intermediate shaft 45. The second gear 42 and the third gear 43 are connected through the intermediate shaft 45. The second gear 42 and the third gear 43 rotate about the intermediate axis J2. The second gear 42 meshes with the first gear 41. The third gear 43 meshes with a ring gear 51 described later of the differential gear 5. The outer diameter of the second gear 42 is larger than the outer diameter of the third gear 43. In the present embodiment, the lower end of the second gear 42 is the lowermost part of the reduction gear 4.

The torque output from the motor 2 is transmitted to the differential gear 5 through the reduction gear 4. More specifically, the torque output from the motor 2 is transmitted to the ring gear 51 of the differential gear 5 through the shaft 21, the first gear 41, the second gear 42, the intermediate shaft 45, and the third gear 43 in this order. The gear ratio of each gear, the number of gears, and the like can be variously changed according to the required reduction ratio. In the present embodiment, the reduction gear 4 is a speed reducer of a parallel-axis gearing type, in which center axes of the gears are arranged in parallel with each other.

The differential gear 5 is connected to the reduction gear 4. As a result, the differential gear 5 is connected to the motor 2 through the reduction gear 4. The differential gear 5 is a device for transmitting the torque output from the motor 2 to the wheels of the vehicle. The differential gear 5 transmits the same torque to axles 55 of the right and left wheels while absorbing the speed difference between the right and left wheels when the vehicle turns. The differential gear 5 rotates the axle 55 about a differential axis J3. As a result, the drive device 1 rotates the axle 55 of the vehicle. The differential axis J3 extends in the right-left direction of the vehicle, i.e., the vehicle width direction of the vehicle. In the present embodiment, the differential axis J3 is parallel to the motor axis J1.

The differential gear 5 includes the ring gear 51, a gear housing (not illustrated), a pair of pinion gears (not illustrated), a pinion shaft (not illustrated), and a pair of side gears (not illustrated). The ring gear 51 is a gear rotating about the differential axis J3. The ring gear 51 meshes with the third gear 43. As a result, the torque output from the motor 2 is transmitted to the ring gear 51 through the reduction gear 4. The lower end of the ring gear 51 is located lower than the reduction gear 4. In the present embodiment, the lower end of the ring gear 51 is the lowermost part of the differential gear 5.

The housing 6 is an outer casing of the drive device 1. The housing 6 includes the partition wall 61c axially partitioning the inside of the motor accommodation part 81 and the inside of the gear accommodation part 82. The partition wall 61c is provided with a partition wall opening 68. The inside of the motor accommodation part 81 and the inside of the gear accommodation part 82 are connected to each other through the partition wall opening 68.

Oil O is accommodated in the housing 6. More specifically, the oil O is accommodated inside the motor accommodation part 81 and inside the gear accommodation part 82. A lower region inside the gear accommodation part 82 is provided with an oil sump P for accumulating the oil O. An oil surface S of the oil sump P is located higher than the lower end of the ring gear 51. As a result, the lower end of the ring gear 51 is immersed in the oil O in the gear accommodation part 82. The oil surface S of the oil sump P is located lower than the differential axis J3 and the axle 55.

The oil O in the oil sump P is fed to the inside of the motor accommodation part 81 through an oil passage 90 described later. The oil O fed to the inside of the motor accommodation part 81 is accumulated in a lower region inside the motor accommodation part 81. At least some of the oil O having accumulated in the motor accommodation part 81 moves to the gear accommodation part 82 through the partition wall opening 68 and is returned to the oil sump P.

Note that in the present specification, when “oil is accommodated in a certain part”, the oil needs to be positioned inside the certain part at least partly during driving of the motor, and thus the oil does not need to be positioned inside the certain part when the motor is stopped. For example, when the oil O is accommodated in the motor accommodation part 81 in the present embodiment, the oil O only needs to be positioned in the motor accommodation part 81 at least partly during driving of the motor 2, and the oil O in the motor accommodation part 81 may entirely be moved to the gear accommodation part 82 through the partition wall opening 68 when the motor 2 is stopped. Note that, some of the oil O fed to the inside of the motor accommodation part 81 through the oil passage 90 described later may remain inside the motor accommodation part 81 in a state in which the motor 2 is stopped.

In the present description, when “the lower end of the ring gear is immersed in the oil in the gear accommodation part”, the lower end of the ring gear only needs to be immersed in the oil in the gear accommodation part at least partly during driving of the motor, and the lower end of the ring gear does not need to be immersed in the oil in the gear accommodation part partly during driving of the motor or stoppage of the motor. For example, as a result of the oil O in the oil sump P being sent to the inside of the motor accommodation part 81 by the oil passage 90 described later, the oil surface S of the oil sump P may be lowered, and the lower end of the ring gear 51 may temporarily be out of the oil O.

The oil O circulates through the oil passage 90 described later. The oil O is used for lubrication of the reduction gear 4 and the differential gear 5. The oil O is used for cooling the motor 2. An oil equivalent to a lubricating oil (ATF: automatic transmission fluid) for an automatic transmission having a relatively low viscosity is preferably used as the oil O so that the oil O can perform functions of a lubricating oil and a cooling oil.

A bottom 82a of the gear accommodation part 82 is located lower than a bottom 81a of the motor accommodation part 81. For this reason, the oil O fed from the gear accommodation part 82 to the motor accommodation part 81 easily flows into the gear accommodation part 82 through the partition wall opening 68.

The drive device 1 is provided with the oil passage 90 through which the oil O circulates inside the housing 6. The oil passage 90 is a path for supplying the oil O from the oil sump P to the motor 2 and guiding the oil O to the oil sump P again. The oil passage 90 is provided across the inside of the motor accommodation part 81 and the inside of the gear accommodation part 82.

Note that the term “oil passage” as used herein refers to a path of an oil. Accordingly, the term “oil passage” is a concept including not only a “flow path” that creates a steady unidirectional flow of oil, but also a path for temporarily retaining oil and a path for oil to drip off. Examples of the path for temporarily retaining oil include a reservoir for storing oil.

The oil passage 90 includes a first oil passage 91 and a second oil passage 92. Each of the first oil passage 91 and the second oil passage 92 circulates the oil O inside the housing 6. The first oil passage 91 includes a scoop path 91a, a shaft supply path 91b, an in-shaft path 91c, and an in-rotor path 91d. A first reservoir 93 is provided in the path of the first oil passage 91. The first reservoir 93 is provided in the gear accommodation part 82.

The scoop path 91a is a path for scraping up the oil O from the oil sump P by rotation of the ring gear 51 of the differential gear 5 and receiving the oil O by the first reservoir 93. The first reservoir 93 opens upward. The first reservoir 93 receives the oil O scraped up by the ring gear 51. When the liquid level of the oil sump P is high immediately after the motor 2 is driven, the first reservoir 93 also receives the oil O scraped up by the second gear 42 and the third gear 43 in addition to the ring gear 51.

The oil O scraped up by the ring gear 51 is also supplied to the reduction gear 4 and the differential gear 5. As a result, the oil O accommodated in the housing 6 is supplied to the transmission device 3. The oil O supplied to the transmission device 3 is supplied as lubricating oil to the gear of the reduction gear 4 and the gear of the differential gear 5. Note that the oil O scraped up by the ring gear 51 may be supplied to either the reduction gear 4 or the differential gear 5.

The shaft supply path 91b guides the oil O from the first reservoir 93 into the hollow part 22 of the shaft 21. The in-shaft path 91c is a path for the oil O to pass through the hollow part 22 of the shaft 21. The in-rotor path 91d is a path for the oil O to pass through the communicating hole 23 of the shaft 21 and the inside of the rotor body 24 to be scattered to the stator 30.

In the in-shaft path 91c, a centrifugal force is applied to the oil O in the rotor 20 due to the rotation of the rotor 20. This causes the oil O to be continuously scattered radially outward from the rotor 20. The scattering of the oil O generates a negative pressure in the path inside the rotor 20, causing the oil O accumulated in the first reservoir 93 to be sucked into the rotor 20, so that the path in the rotor 20 is filled with the oil O.

The oil O that reaches the stator 30 absorbs heat from the stator 30. The oil O having cooled the stator 30 drips down, and is accumulated in a lower region in the motor accommodation part 81. The oil O having accumulated in the lower region in the motor accommodation part 81 moves to the gear accommodation part 82 through the partition wall opening 68 provided in the partition wall 61c. In the above-described manner, the first oil passage 91 supplies the oil O to the rotor 20 and the stator 30.

In the second oil passage 92, the oil O is raised from the oil sump P to the upper side of the stator 30 to be supplied to the stator 30. That is, the second oil passage 92 supplies the oil O to the stator 30 from the upper side of the stator 30. The second oil passage 92 is provided with the electric oil pump 96, the oil cooler 97, and a second reservoir 10. The second oil passage 92 includes a first flow path 92a, a second flow path 92b, and a third flow path 92c.

Each of the first flow path 92a, the second flow path 92b, and the third flow path 92c is provided in a wall part of the housing 6. The first flow path 92a joins the oil sump P and the electric oil pump 96 to each other. The second flow path 92b joins the electric oil pump 96 and the oil cooler 97. The third flow path 92c extends upward from the oil cooler 97. The third flow path 92c is provided in a wall part of the motor accommodation part 81. Although not illustrated, the third flow path 92c includes a supply port opening inside the motor accommodation part 81 above the stator 30. The supply port supplies the oil O to the inside of the motor accommodation part 81.

The electric oil pump 96 is an electric oil pump driven by electricity. The electric oil pump 96 sends the oil O accommodated in the housing 6 to the motor 2. In the present embodiment, the electric oil pump 96 sucks up the oil O from the oil sump P through the first flow path 92a, and supplies the oil O to the motor 2 through the second flow path 92b, the oil cooler 97, the third flow path 92c, and the second reservoir 10. As illustrated in FIG. 1, the electric oil pump 96 includes a motor part 96a, a pump part 96b, and a rotation sensor 72. The pump part 96b is rotated by the motor part 96a. Although not illustrated, the pump part 96b includes an inner rotor connected to the motor part 96a and an outer rotor surrounding the inner rotor. The electric oil pump 96 sends the oil O to the motor 2 by rotating the pump part 96b by the motor part 96a.

The rotation sensor 72 can detect the rotation of the pump part 96b. In the present embodiment, by detecting the rotation of the motor part 96a, the rotation sensor 72 can detect the rotation of the pump part 96b rotated by the motor part 96a. The type of the rotation sensor 72 is not particularly limited as long as the rotation of the pump part 96b can be detected. The rotation sensor 72 may be a magnetic sensor, may be a resolver, or may be an optical sensor. If the rotation sensor 72 is a magnetic sensor, the rotation sensor 72 may be a Hall element such as a Hall IC or may be a magnetoresistive element. Note that the rotation sensor 72 may directly detect the rotation of the pump part 96b. The detection result of the rotation sensor 72 is sent to the control unit 70 described later.

As illustrated in FIG. 2, the oil cooler 97 cools the oil O passing through the second oil passage 92. The second flow path 92b and the third flow path 92c are connected to the oil cooler 97. The second flow path 92b and the third flow path 92c are connected through an internal flow path of the oil cooler 97. As illustrated in FIG. 1, a refrigerant W cooled by a radiator 110 is supplied to the oil cooler 97 by a refrigerant pump 120 through a refrigerant flow path 150. The oil O passing through the inside of the oil cooler 97 is cooled by heat exchange with the refrigerant W passing through the refrigerant flow path 150. The oil O cooled by the oil cooler 97 is the oil O sent by the electric oil pump 96. That is, the refrigerant W sent from the refrigerant pump 120 cools the oil O sent by the electric oil pump 96 in the oil cooler 97.

As illustrated in FIG. 2, the second reservoir 10 forms a part of the second oil passage 92. The second reservoir 10 is located inside the motor accommodation part 81. The second reservoir 10 is located above the stator 30. The second reservoir 10 is supported from below by the stator 30, and is provided in the motor 2. The second reservoir 10 is made of, for example, a resin material.

In the present embodiment, the second reservoir 10 is in a shape of a gutter opening upward. The second reservoir 10 stores the oil O. In the present embodiment, the second reservoir 10 stores the oil O supplied in the motor accommodation part 81 through the third flow path 92c. The second reservoir 10 includes a plurality of supply ports 10a for supplying the oil O to the coil ends 33a and 33b and the bearings 26 and 27. As a result, the oil O stored in the second reservoir 10 can be supplied to the stator 30 and the bearings 26 and 27. The drive device 1 may have a guide mechanism such as a pipe or a gutter that guides the oil O from the second reservoir 10 to the coil ends 33a and 33b. The drive device 1 may have a guide mechanism such as a pipe or a gutter that guides the oil O from the second reservoir 10 to the bearings 26 and 27.

The oil O supplied from the second reservoir 10 to the stator 30 drips down, and is accumulated in the lower region in the motor accommodation part 81. The oil O having accumulated in the lower region in the motor accommodation part 81 moves to the gear accommodation part 82 through the partition wall opening 68 provided in the partition wall 61c. In the above-described manner, the second oil passage 92 supplies the oil O to the stator 30.

As illustrated in FIG. 1, the inverter unit 8 includes the control unit 70. That is, the drive device 1 includes the control unit 70. The control unit 70 controls the motor 2 and the motor part 96a of the electric oil pump 96. The control unit 70 includes a motor control unit 171 that controls the motor 2 and an electric oil pump control unit 172 that controls the electric oil pump 96.

The motor control unit 171 includes an inverter circuit for adjusting power supplied to the motor 2. The electric oil pump control unit 172 includes control mode switching means 172a and pump driving means 172b. In oil supply processing, the control mode switching means 172a switches between and executes a normal control mode in which the output of the electric oil pump 96 is changed in a plurality of stages on the basis of the temperature and a startup mode in which the electric oil pump 96 is operated for a predetermined time with the maximum output in the normal control mode at the start of power supply. The pump driving means 172b operates the electric oil pump 96.

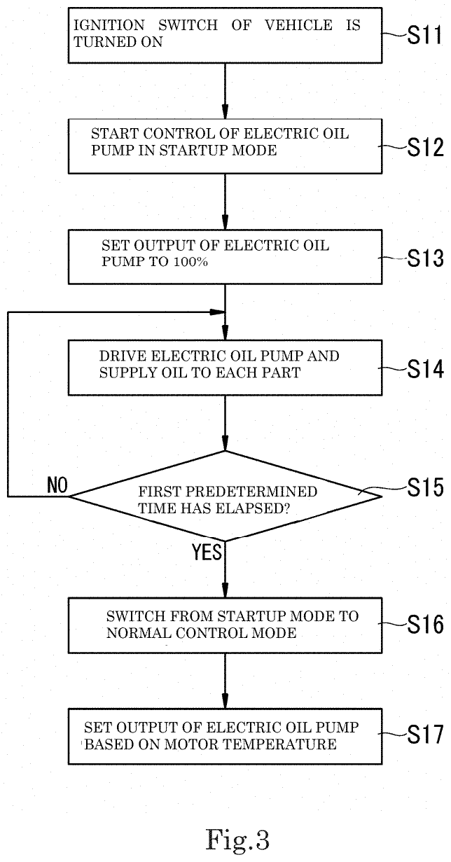

FIG. 3 is a flowchart illustrating an example of a drive device control method of the present embodiment. In the present embodiment, the control unit 70 performs control according to steps S11 to S16 shown in FIG. 3.

When the ignition switch IGS of the vehicle is turned on in step S11, the control unit 70 performs step S12. In step S12, the control unit 70 starts drive control of the electric oil pump 96 in the startup mode. That is, the control unit 70 switches the control mode of the electric oil pump control unit 172 to the startup mode by the control mode switching means 172a of the electric oil pump control unit 172.

In step S13, the electric oil pump control unit 172 sets the output of the electric oil pump 96 to 100%. The output 100% in step S13 means the maximum output of the electric oil pump 96 in the normal control mode. The normal control mode is a control mode of the electric oil pump 96 during a power ON period of the drive device 1 other than at the start of power supply. In the normal control mode, the electric oil pump control unit 172 of the present embodiment changes the output of the electric oil pump 96 in a plurality of stages on the basis of temperature information of the motor 2. In the startup mode, the electric oil pump 96 is set to the maximum output among the outputs of the plurality of stages in the normal control mode.

In steps S14 and S15, the electric oil pump control unit 172 drives the electric oil pump 96 at the maximum output for a first predetermined time through the pump driving means 172b. A first predetermined time is, for example, 5 seconds or more and 15 seconds or less. By driving the electric oil pump 96 at the maximum output for a predetermined time in the startup mode, the oil O is promptly supplied to each part of the drive device 1 after the start of power supply. That is, the oil O sent from the electric oil pump 96 is supplied to the bearings 26 and 27 through the oil cooler 97 and the second reservoir 10.

Normally, the flow rate of the electric oil pump 96 is controlled according to the rotational speed of the motor 2. Accordingly, during a period in which the motor 2 stops or rotates at a low speed immediately after the start of power supply, the electric oil pump 96 operates at a low speed. However, when the temperature is extremely low (−40° C. or higher and 0° C. or lower), the oil O has a high viscosity. Hence, in the electric oil pump 96 operating at a low speed, it takes time to spread the oil O throughout the inside of the drive device 1. For this reason, there is a possibility that the bearings 26 and 27 become insufficient in lubrication and the life thereof is shortened.

Against this background, in the present embodiment, the electric oil pump 96 is operated at the maximum output regardless of the rotation speed of the motor 2 for a predetermined time after the start of power supply. As a result, the oil O can be forcibly flowed even in at an extremely low temperature, and the bearings of each part of the device including the bearings 26 and 27 illustrated in FIG. 2 can be promptly lubricated.

After the lapse of the first predetermined time, step S16 is executed. In step S16, the electric oil pump control unit 172 switches the control mode of the electric oil pump 96 from the startup mode to the normal control mode by the control mode switching means 172a. Thereafter, step S17 is executed.

In step S17, the control unit 70 sets the output of the electric oil pump 96 on the basis of the temperature of the motor 2. In the case of the present embodiment, the control unit 70 acquires the temperature of the coil assembly 33 measured by the temperature sensor 71 as the temperature of the motor 2. The electric oil pump control unit 172 sets the output of the electric oil pump 96 on the basis of the temperature of the motor 2.

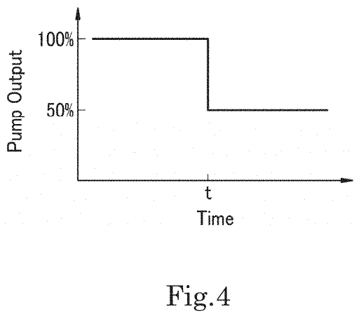

FIG. 4 is a graph conceptually illustrating the relationship between the elapsed time from the start of power supply and the output of the electric oil pump 96 in the present embodiment. In the case of the present embodiment, the electric oil pump 96 is operated at the maximum output (100%) immediately after the start of the drive device 1. After the lapse of the first predetermined time, at time t, the output of the electric oil pump 96 is changed to a value based on the temperature of the motor 2. In FIG. 4, as an example, the value is displayed as an output of 50%.

When the vehicle is in the normal traveling mode, the temperature of the motor 2 rises and falls according to the rotation speed of the motor 2. When the temperature of the motor 2 becomes high, the output of the electric oil pump 96 is increased to increase the flow rate of the oil O in order to cool the motor 2 with the oil O. When the temperature of the motor 2 decreases, the output of the electric oil pump 96 is reduced, and the flow rate of the oil O is reduced.

As described above, in the present embodiment, the control unit 70 supplies the oil O to the bearing of each part of the drive device 1 to lubricate the bearing by setting the electric oil pump 96 to the maximum output for a predetermined time immediately after the ignition switch IGS of the vehicle is turned on. For this reason, even at an extremely low temperature where the oil O has a high viscosity, insufficient lubrication is unlikely to occur, and the bearings 26 and 27 and the like can be smoothly lubricated even if the motor 2 is immediately rotated after the start of power supply.

In the present embodiment, in step S17, temperature information acquired by the temperature sensor 71 that measures the coil temperature of the stator 30 is used. According to this configuration, the output of the electric oil pump 96 can be adjusted on the basis of temperature information that tracks the rotation speed of the motor 2 reliably. The deviation between the temperature change of the motor 2 and the supply timing of the oil O to the motor 2 is reduced, and the motor 2 can be cooled efficiently. Note that in step S17, the temperature information of the rotor 20 may be used as the temperature information of the motor 2.

The control method of the present embodiment is a control method of, in oil supply processing, switching between and executing a normal control mode in which the output of the electric oil pump 96 is changed in a plurality of stages according to the temperature of the stator 30 or the rotor 20, and a startup mode in which the electric oil pump 96 is operated for a predetermined time with the maximum output in the normal control mode at the start of power supply. According to this control method, the electric oil pump 96 can promptly supply the oil O to the bearing in the drive device 1 at the start of power supply when the bearing is likely to be insufficient in lubrication, whereby the bearing can be smoothly lubricated. After the lapse of the predetermined time, the output of the electric oil pump 96 is adjusted on the basis of the temperature of the motor 2. Hence, the motor 2 can be efficiently cooled while suppressing power consumption of the electric oil pump 96.

### Second Embodiment

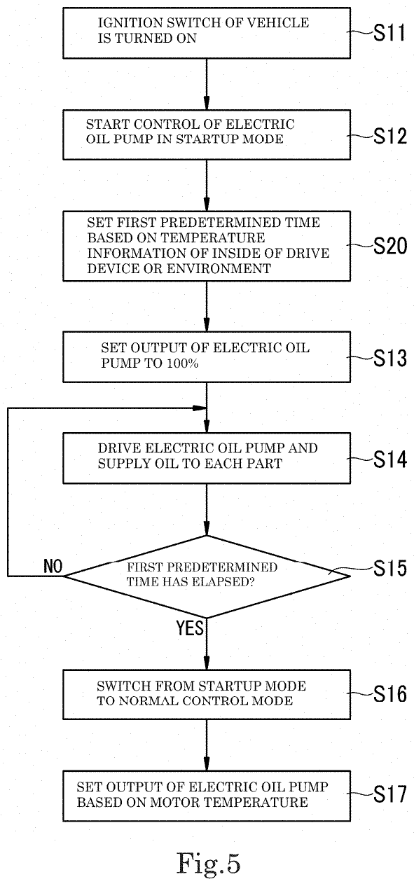

FIG. 5 is a flowchart illustrating a drive device control method of the present embodiment. The control method of the present embodiment is common to the first embodiment in including steps S11 to S16, and is different from the first embodiment in including step S20 between steps S12 and S13. Specific processing of the drive device 1 performed in steps S11 to S16 is the same as that in the first embodiment.

In a drive device 1 of the present embodiment, as illustrated by an imaginary line in FIG. 1, an electric oil pump control unit 172 includes operation time setting means 172c, and includes a temperature sensor 73 arranged in an oil sump P. The temperature sensor 73 is immersed in an oil O stored in the oil sump P. A control unit 70 can measure the oil temperature by the temperature sensor 73. The temperature sensor 73 may be located at a position other than the oil sump P as long as the temperature of the oil O can be measured. The temperature sensor 73 is provided as necessary.

As illustrated in FIG. 5, the control method of the present embodiment sets a first predetermined time for operating an electric oil pump 96 at the maximum output on the basis of temperature information in a startup mode started in step S12 (step S20). Thereafter, in steps S13 to S15, the electric oil pump 96 is operated at the maximum output for the first predetermined time.

Specifically, in step S12, the control unit 70 switches the control mode of the electric oil pump control unit 172 to the startup mode by control mode switching means 172a of the electric oil pump control unit 172. The electric oil pump control unit 172 executes step S20 and steps S13 to S15 in the startup mode.

In step S20, the electric oil pump control unit 172 sets the first predetermined time for operating the electric oil pump 96 at the maximum output on the basis of temperature information by the operation time setting means 172c. As the temperature information, temperature information of the inside of the drive device 1 or the environment can be used.

As the temperature information of the environment, the outside air temperature of the vehicle can be used. As illustrated in FIG. 1, a vehicle control device 140 can acquire the outside air temperature around the vehicle by an outside air temperature sensor ATS installed in the vehicle. When setting the first predetermined time, the electric oil pump control unit 172 can use, as temperature information, the outside air temperature input from the vehicle control device 140 that is the host device.

As the temperature information inside the drive device 1, the coil temperature of the stator 30 that can be acquired by the temperature sensor 71 or the oil temperature that can be acquired by the temperature sensor 73 can be used. Hereinafter, a case where the first predetermined time is set on the basis of the oil temperature will be described.

For example, as shown in the following Table 1, the operation time setting means 172c selects one of set values of a plurality of levels on the basis of the oil temperature input to the electric oil pump control unit 172, and sets the selected set value as the first predetermined time. In the example shown in Table 1, the lower the oil temperature, the longer the first predetermined time.

When the oil temperature is 100° C. or higher as shown in Level 1, it is estimated that the vehicle is in a state immediately after ignition OFF, the viscosity of the oil O is low, and each bearing in the drive device 1 is sufficiently lubricated. For this reason, since it is not necessary to forcibly spread the oil O by the electric oil pump 96, the first predetermined time is set to 0 seconds. The setting value of the first predetermined time can be appropriately changed according to the configuration of the drive device 1. In Table 1, the setting value of the first predetermined time is divided into four stages, but may be divided into three stages or less, or five stages or more. By adopting a method of selecting the setting value of the first predetermined time from a plurality of levels, the calculation amount can be reduced, and complication of the electric oil pump control unit 172 can be curbed.

Note that the operation time setting means 172c may determine the first predetermined time corresponding to the oil temperature on the basis of a relational expression associating the oil temperature with the first predetermined time.

TABLE 1

| | Oil temperature | First predetermined time |
|---|---|---|
| Level 1 | 100° C. or higher | 0 seconds |
| Level 2 | 30° C. to 100° C. | 7 seconds |
| Level 3 | 0° C. to 30° C. | 10 seconds |
| Level 4 | −40° C. to 0° C. | 15 seconds |

After the first predetermined time is set in step S20, the processing proceeds to step S13. The operations of the electric oil pump control unit 172 and the electric oil pump 96 in steps S13 to S15 are similar to those in the first embodiment. The electric oil pump control unit 172 operates the electric oil pump 96 at an output of 100% for the first predetermined time to forcibly flow the oil O. This makes it possible to promptly lubricate the bearings of each part of the apparatus including the bearings 26 and 27 illustrated in FIG. 2, particularly at an extremely low temperature.

The operations of the electric oil pump control unit 172 and the electric oil pump 96 in steps S16 and S17 are also similar to those in the first embodiment. After the lapse of the first predetermined time, the electric oil pump control unit 172 shifts to the normal control mode and controls the output of the electric oil pump 96 on the basis of the motor temperature.

According to the drive device and the control method thereof of the present embodiment described above, in step S20, the operation time setting means 172c sets the operation processing time for operating the electric oil pump 96 at the maximum output on the basis of the oil temperature. The electric oil pump control unit 172 drives the electric oil pump 96 at the maximum output for the set first predetermined time. That is, according to the control method of the present embodiment, time t illustrated in FIG. 4 varies depending on the oil temperature.

According to the above control method, when the oil temperature is relatively high and the viscosity of the oil O is low, the time for operating the electric oil pump 96 at the maximum output can be shortened, and power consumption of the electric oil pump 96 can be reduced. On the other hand, when the oil temperature is low and the viscosity of the oil O is high, the electric oil pump 96 is operated at the maximum output for a relatively long time, so that the oil O having low fluidity can be spread to the bearing located away from the electric oil pump 96.

### Third Embodiment

In a drive device 1 of the present embodiment, as illustrated by an imaginary line in FIG. 1, an electric oil pump control unit 172 includes output setting means 172d. The output setting means 172d sets the output of an electric oil pump 96 within the range of the output value including the maximum output in oil supply processing at the start of power supply. In the case of the present embodiment, the electric oil pump control unit 172 does not need to include the operation time setting means 172c.

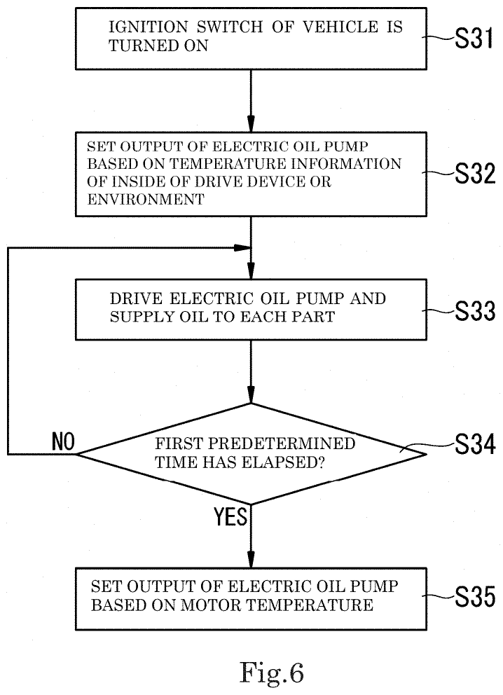

FIG. 6 is a flowchart illustrating a drive device control method of the present embodiment. The control method of the present embodiment includes steps S31 to S36.

When an ignition switch IGS of the vehicle is turned on in step S31, a control unit 70 performs step S32. In step S32, the electric oil pump control unit 172 of a control unit 70 sets the output of the electric oil pump 96 on the basis of temperature information of the inside of the drive device 1 or the environment by the output setting means 172d.

The output setting means 172d can use temperature information similar to that of the second embodiment. That is, the output setting means 172d can use the outside air temperature of the vehicle as the temperature information of the environment. As the temperature information inside the drive device 1, the coil temperature of a stator 30 that can be acquired by a temperature sensor 71 or the oil temperature that can be acquired by a temperature sensor 73 can be used.

Hereinafter, a case where the output of the electric oil pump 96 is set on the basis of the oil temperature will be described.

For example, as shown in the following Table 2, the output setting means 172d selects one of output values of a plurality of levels on the basis of the oil temperature input to the electric oil pump control unit 172, and sets the selected output value as the output of the electric oil pump 96. In the example shown in Table 2, the lower the oil temperature, the larger the output of the electric oil pump 96.

When the oil temperature is 100° C. or higher as shown in Level 1, it is estimated that the vehicle is in a state immediately after ignition OFF, the viscosity of the oil O is low, and each bearing in the drive device 1 is sufficiently lubricated. For this reason, it is less necessary to forcibly spread the oil O by the electric oil pump 96. In Table 2, the output is set to 30%, but the output may be set by a method similar to the normal control mode of the first embodiment. That is, when the oil temperature is 100° C. or higher, the electric oil pump control unit 172 may set the output of the electric oil pump 96 on the basis of the temperature of the motor 2. The specific output setting procedure is similar to step S17 of the first embodiment.

The set value of the output of the electric oil pump 96 can be appropriately changed according to the configuration of the drive device 1. In Table 2, the output value is divided into four stages, but may be divided into three stages or less, or five stages or more. By adopting a method of selecting the output value from a plurality of levels, the calculation amount can be reduced, and complication of the electric oil pump control unit 172 can be curbed. Note that the output setting means 172d may determine the output of the electric oil pump 96 corresponding to the oil temperature on the basis of a relational expression associating the oil temperature with the output value.

TABLE 2

| | Oil temperature | Output of electric oil pump |
|---|---|---|
| Level 1 | 100° C. or higher | 30% |
| Level 2 | 30° C. to 100° C. | 50% |
| Level 3 | 0° C. to 30° C. | 70% |
| Level 4 | −40° C. to 0° C. | 100% |

In steps S33 and S34, the electric oil pump control unit 172 drives the electric oil pump 96 for a first predetermined time with the output set in step S32 through the pump driving means 172b. A first predetermined time is, for example, 5 seconds or more and 15 seconds or less. By driving the electric oil pump 96 for a predetermined time, the oil O is promptly supplied to each part of the drive device 1 after the start of power supply.

After the lapse of the first predetermined time, step S35 is executed. In step S35, the control unit 70 sets the output of the electric oil pump 96 on the basis of the temperature of a motor 2. The specific operation in step S35 is similar to that in step S17 of the first embodiment.

According to the drive device and the control method thereof of the present embodiment described above, the electric oil pump 96 is always driven for a predetermined time with an output value based on the temperature information at the start of power supply. That is, according to the control method of the present embodiment, the output of the electric oil pump 96 from the startup to time t in FIG. 4 varies depending on the oil temperature.

According to this control method, when the oil temperature is relatively high and the viscosity of the oil O is low, the electric oil pump 96 is operated at a relatively small output, and power consumption of the electric oil pump 96 can be reduced. On the other hand, when the oil temperature is low and the viscosity of the oil O is high, the electric oil pump 96 is operated at a relatively large output including the maximum output, so that the oil O having low fluidity can be spread to the bearing located away from the electric oil pump 96.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A drive device comprising:
a motor including a rotor and a stator;
a transmission device including a reduction gear connected to the motor;
a housing that accommodates the motor and the transmission device;
an electric oil pump that conveys oil in the housing; and
a control unit including a motor control unit that controls the motor and an electric oil pump control unit that controls the electric oil pump,
wherein
the electric oil pump control unit includes
control mode switching means that, in oil supply processing, switches between and executes a normal control mode in which an output of the electric oil pump is changed in a plurality of stages according to a temperature of the stator or the rotor, and a startup mode in which the electric oil pump is operated at a maximum output in the normal control mode for a predetermined time at the start of power supply, and
pump driving means that operates the electric oil pump.

2. The drive device according to claim 1, wherein
the electric oil pump control unit includes
operation time setting means that sets a time for operating the electric oil pump at a maximum output on the basis of temperature information of the motor input to the electric oil pump control unit in the startup mode, and
the pump driving means operates the electric oil pump at a maximum output for a time set by the operation time setting means.

3. The drive device according to claim 2, wherein
the temperature information is an internal temperature input from a temperature sensor located inside the housing or an environmental temperature input from a host device.

4. The drive device according to claim 3, wherein
the temperature sensor is a sensor that measures a coil temperature of the stator.

5. The drive device according to claim 3, wherein
the temperature sensor is a sensor that measures an oil temperature in the housing.

6. The drive device according to claim 3, wherein
the temperature information is an outside air temperature.

7. The drive device according to claim 2, wherein
the electric oil pump control unit selects a time for operating the electric oil pump at a maximum output from a plurality of levels on the basis of the temperature information.

8. The drive device according to claim 1, wherein
the electric oil pump control unit shifts to the normal control mode after the lapse of a time for operating the electric oil pump at a maximum output in the startup mode.

9. A drive device comprising:
a motor including a rotor and a stator;
a transmission device including a reduction gear connected to the motor;
a housing that accommodates the motor and the transmission device;
an electric oil pump that conveys oil in the housing; and
a control unit including a motor control unit that controls the motor and an electric oil pump control unit that controls the electric oil pump,
wherein
the electric oil pump control unit includes output setting means that sets an output of the electric oil pump in oil supply processing at the start of power supply, and
the output setting means sets an output of the electric oil pump within a range of an output value including a maximum output of the electric oil pump on the basis of temperature information input to the electric oil pump control unit from the motor control unit or a host device.

10. The drive device according to claim 9, wherein
the electric oil pump control unit selects an output value of the electric oil pump from a plurality of levels on the basis of the temperature information.

11. A control method of a drive device including:
a motor including a rotor and a stator;
a transmission device including a reduction gear connected to the motor;
a housing that accommodates the motor and the transmission device; and
an electric oil pump that conveys oil in the housing, the method comprising
in oil supply processing, switching between and executing
a normal control mode in which an output of the electric oil pump is changed in a plurality of stages according to a temperature of the stator or the rotor, and
a startup mode in which the electric oil pump is operated at a maximum output in the normal control mode for a predetermined time at the start of power supply.

12. The drive device control method according to claim 11, wherein
in the startup mode, a time for operating the electric oil pump at a maximum output is set on the basis of temperature information, and the electric oil pump is operated at a maximum output for the set time.

13. The drive device control method according to claim 12, wherein
the temperature information is an internal temperature input from a temperature sensor located inside the housing or an environmental temperature input from a host device.

14. The drive device control method according to claim 13, wherein
the temperature sensor is a sensor that measures a coil temperature of the stator.

15. The drive device control method according to claim 13, wherein
the temperature sensor is a sensor that measures an oil temperature in the housing.

16. The drive device control method according to claim 13, wherein
the temperature information is an outside air temperature.

17. The drive device control method according to claim 12, wherein
a time for operating the electric oil pump at a maximum output is selected from a plurality of levels on the basis of the temperature information.

18. The drive device control method according to claim 11 further comprising
shifting to the normal control mode after the lapse of a time for operating the electric oil pump at a maximum output in the startup mode.

19. A control method of a drive device including:
a motor including a rotor and a stator;
a transmission device including a reduction gear connected to the motor;
a housing that accommodates the motor and the transmission device; and
an electric oil pump that conveys oil in the housing, the method comprising
in oil supply processing at the start of power supply, setting an output of the electric oil pump within a range of an output value including a maximum output of the electric oil pump on the basis of temperature information input from a host device or the motor and operating the electric oil pump with the set output.

20. The drive device control method according to claim 19 further comprising
selecting an output value of the electric oil pump from a plurality of levels on the basis of the temperature information.
